(19) United States
(12) Patent Application Publication
(10) Pub. No.: US 2021/0324145 A1
(43) Pub. Date: Oct. 21, 2021

(54) Polyimide Film and Window Cover Film Including the Same

(71) Applicants: SK Innovation Co., Ltd., Seoul (KR); SK IE Technology Co., Ltd., Seoul (KR)

(72) Inventors: Jong Nam Ahn, Daejeon (KR); Hye Jin Kim, Daejeon (KR)

(21) Appl. No.: 17/233,634

(22) Filed: Apr. 19, 2021

(30) Foreign Application Priority Data
Apr. 20, 2020 (KR) 10-2020-0047388

(51) Int. Cl. C08G 73/14; C08J 5/18; C09D 5/00

(52) U.S. Cl. CPC C08G 73/14; C08J 2379/08; C09D 5/006; C08J 5/18

(57) ABSTRACT

Provided are a polyimide-based film, a window cover film, and a display panel including the same. More specifically, provided are a polyimide-based film having high tear strength and excellent optical properties, a window cover film, and a display panel including the same.

### CROSS-REFERENCE TO RELATED APPLICATION

This application claims priority to Korean Patent Application No. 10-2020-0047388 filed Apr. 20, 2020, the disclosure of which is hereby incorporated by reference in its entirety.

### BACKGROUND OF THE INVENTION

### Field of the Invention

The following disclosure relates to a polyimide-based film, a window cover film, and a display panel including the same.

### Description of Related Art

A thin display device such as a liquid crystal display or an organic light emitting diode display has been implemented in a form of a touch screen panel, and has been widely used in various smart devices characterized by portability, such as various wearable devices as well as smartphones and tablet personal computers (PCs).

These portable touch screen panel-based display devices include a window cover for display protection on a display panel in order to protect the display panel from scratches or external impact. Recently, in accordance with the development of a foldable display device that may be folded and unfolded and has flexibility, a glass material of such a window cover has been replaced with a plastic film.

As the foldable display device, there are an out-fold-type foldable display device in which a display is out-folded to be exposed, and an in-fold-type foldable display device in which a display is in-folded to be hidden. In addition, a Z-fold-type display device in which a display is folded multiple times in in-fold and out-fold manners, has been developed, and a window cover film suitable for being applied to such a foldable display device has been developed. However, unlike the above-described type, a flexible display device that may be in-folded and out-folded at a specific position thereof has been required.

A material having transparency like a glass while having excellent mechanical properties is required, in order to use the material as a base material for a window cover film of such a flexible display device, etc., that may be in-folded and out-folded. In addition, since there are problems such as cracks and peel-off caused by fatigue of a folded portion, it has been required to develop a material that minimizes deformation of the folded portion even in repeated folding and unfolding operations.

Korean Patent Laid-Open Publication No. 10-2012-0078510 (published on Jul. 10, 2012) discloses that an additive for improving a tear strength, such as polyphenylsilsesquioxane, is used to improve the tear strength, and shows that a film having a high yellow index of 3.37 or more and a tear strength of about 138.7 to 184.6 N/mm is manufactured when a thickness of the film is 100 μm. However, a film having a yellow index lower than the yellow index described above to have improved transparency and having a higher tear strength has been required.

### RELATED ART DOCUMENT

[Patent Document]

Korean Patent Laid-Open Publication No. 10-2012-0078510 (published on Jul. 10, 2012)

### SUMMARY OF THE INVENTION

An embodiment of the present invention is directed to providing a film capable of having a higher tear strength than the related art, evenly exhibiting a tear strength over an entire area of the film, and having a low yellow index to have excellent optical properties.

Another embodiment of the present invention is directed to providing a polyimide-based film in which deformation of a folded portion may be minimized and occurrence of a folded mark may be minimized even if in-fold and out-fold are continuously repeated at the same position, and a window cover film using the same.

Another embodiment of the present invention is directed to providing a polyimide-based film having improved durability and mechanical properties and having excellent optical properties, and a window cover film using the same.

In one general aspect, there is provided a polyimide-based film having a tear strength according to ASTM D1004 of 300 N/mm or more and a yellow index according to ASTM E313 of 3 or less.

The tear strength may be 300 to 700 N/mm, and more specifically 350 to 500 N/mm.

0.95≤T_{MD}/T_{TD}≤1.05 in which T_{MD} is a tear strength of the polyimide-based film in a machine direction(MD) and T_{TD} is a tear strength of the polyimide-based film in a transverse direction(TD).

The yellow index may be 2 to 3.

A light transmittance of the polyimide-based film measured at 388 nm according to ASTM D1746 may be 5% or more, a total light transmittance of the polyimide-based film measured at 400 to 700 nm according to ASTM D1746 may be 87% or more, and a haze of the polyimide-based film may be 2.0% or less.

The light transmittance of the polyimide-based film measured at 388 nm according to ASTM D1746 may be 8% or more, the total light transmittance of the polyimide-based film measured at 400 to 700 nm according to ASTM D1746 may be 89% or more, and the haze of the polyimide-based film may be 1.0% or less.

A modulus of the polyimide-based film according to ASTM D882 may be 3 GPa or more, and an elongation at break of the polyimide-based film according to ASTM D882 may be 8% or more.

An in-plane retardation of the polyimide-based film measured at 550 nm using an Axoscan available from Axometrics, Inc. may be 400 nm or less.

The polyimide-based film may include a polyamide-imide structure.

The polyimide-based film may include a unit derived from an aromatic diamine, a unit derived from an aromatic dianhydride, a unit derived from a cycloaliphatic dianhydride, and a unit derived from an aromatic diacid dichloride, and

the unit derived from an aromatic diacid dichloride may be contained in an amount of 60 mol % or more based on the total moles of the unit derived from an aromatic dianhydride, the unit derived from a cycloaliphatic dianhydride, and the unit derived from an aromatic diacid dichloride.

The unit derived from an aromatic diacid dichloride may be contained in an amount of 70 to 90 mol %.

The thickness of the polyimide-based film may be 10 to 500 μm.

In another general aspect, there is provided a window cover film including the polyimide-based film as described above; and a coating layer formed on at least one surface of the polyimide-based film.

The coating layer may be any one or more selected from the group consisting of an anti-static layer, an anti-fingerprint layer, an anti-fouling layer, an anti-scratch layer, a low refractive layer, an anti-reflection layer, and an impact absorbing layer.

In another general aspect, there is provided a flexible display panel including the polyimide-based film as described above.

### BRIEF DESCRIPTION OF THE DRAWING

FIG. 1 illustrates a shape of a sample for evaluating a tear strength of the present invention.

### DESCRIPTION OF THE INVENTION

Terms used herein have the same meaning as the meaning commonly understood by those skilled in the art, unless defined otherwise. In addition, the terms used herein are only for effectively describing certain embodiments, and are not intended to limit the present invention.

Singular forms used in the detailed description and the claims are intended to include the plural forms unless otherwise indicated in context.

Throughout the present specification describing the invention, unless explicitly described to the contrary, “comprising” any component will be understood to imply the further inclusion of other elements rather than the exclusion of other elements.

A “plurality of drying regions” used herein means that the number of drying regions is two or more, and may be expressed as a first drying region, and a second drying region, etc., from a 1^{st} drying region for convenience. More specifically, the plurality of drying regions may be, but are not limited to, two to ten drying regions, and more specifically three to seven drying regions. In addition, for example, when the number of drying regions is two, a “drying region positioned at a rear end” refers to a second drying region, and a “drying region positioned immediately before the second drying region” refers to a first drying region. When the number of drying regions is three or more, a “drying region positioned at a rear end” refers to a second drying region, a third drying region, etc., except for a first drying region. A “final drying region” refers to a final section of a drying step.

A “plurality of stretching regions” used herein means that the number of stretching regions is two or more, and may be expressed as a first stretching region, a second stretching region, etc., from a 1^{st} stretching region for convenience. More specifically, the plurality of stretching regions may be, but are not limited to, two to ten stretching regions, and more specifically three to seven stretching regions. In addition, the stretching region means that a film is uniaxially stretched in a transverse direction(TD) or is biaxially stretched in a transverse direction(TD) and a machine direction(MD).

A “film” used herein is obtained by applying and drying a “resin solution” onto a base and peeling off it from the base, and may be stretched or unstretched.

The inventors of the present invention have completed the present invention by finding that deformation and cracks of a folded portion may be minimized, even when repeated fatigue occurs by performing in-fold and out-fold at the same point when the tear strength is within a specific range, as a result of performing many studies in order to solve the above problem.

In addition, the inventors of the present invention have completed the present invention by finding that a polyimide-based film using a polyamide-imide resin prepared to have a specific composition and by a specific preparation method satisfies all of physical properties such as high transparency, a low yellow index, and excellent mechanical properties and durability as well as the tear strength and may be thus applied to a window cover film for a flexible display device that may be in-folded and out-folded.

Specifically, the inventors of the present invention have completed the present invention by confirming that the polyimide-based film includes a unit derived from an aromatic diamine, a unit derived from an aromatic dianhydride, a unit derived from a cycloaliphatic dianhydride, and a unit derived from an aromatic diacid dichloride, and

the unit derived from an aromatic diacid dichloride may be contained in an amount of 60 mol % or more, more specifically 60 to 90 mol %, and more preferably 70 to 90 mol %, based on the total moles of the unit derived from an aromatic dianhydride, the unit derived from a cycloaliphatic dianhydride, and the unit derived from an aromatic diacid dichloride to better achieve the physical properties described above.

The inventors of the present invention have also found that a film having a higher tear strength and a lower yellow index may be provided by adopting a specific process at the time of manufacturing the polyimide-based film. This process is not limited as long as physical properties of the present invention may be obtained by adopting a structure of polymer and various processes such as a stretching process and a heat-treatment process.

The inventors of the present invention have completed the present invention by finding that a film in which a tear strength is higher and is evenly exhibited in a transverse direction(TD) and a machine direction(MD), transparency is high, a yellow index is low, a folded mark is hardly generated in repeatedly folding due to excellent durability may be provided, by manufacturing the film by a drying step partitioned into a plurality of drying regions and a stretching step partitioned into a plurality of stretching regions as a specific example of the present invention among these means and performing the processes under a specific condition in this case.

Here, the drying step partitioned into the plurality of drying regions has drying regions of which a drying region positioned at a rear end is set to have a temperature higher than a temperature of a drying region positioned immediately before this drying region, and drying regions positioned at a rear end except for a first drying region are set to have high temperatures that are the same as or exceed temperatures of drying regions positioned immediately before these drying regions, respectively, and in a stretching step partitioned into the plurality of stretching regions, the film may be stretched at a stretching width within 110% of a film width of a first stretching region up to a final stretching region, the respective stretching regions are set to have temperatures higher than temperatures of stretching regions immediate before the respective stretching regions, respectively, and in the final stretching region and two stretching regions from the final stretching region, the film may be shrinkage-stretched to have a stretching width lower than a stretching width in a stretching region positioned immediately before these stretching regions.

Hereinafter, each configuration of the present invention will be described in detail. However, this description is only an example, and the present invention is not limited to a specific embodiment described as an example.

In general, a flexible display device involves repeated deformation (folding) at the time of being used. When fine cracks occur at the time of the deformation of the flexible display device, the number of fine cracks increases as the deformation is repeated. Thus, the fine cracks may be aggregated to form a crack that is visually recognized with the naked eyes. In addition, as the number of cracks increases, flexibility of the flexible display device decreases, such that breakage may occur at the time of additional folding of the flexible display device, and moisture, etc., may penetrate into the cracks to deteriorate durability of the flexible display device.

A polyimide-based film according to exemplary embodiments of the present invention and a window cover film using the same may substantially prevent the occurrence of the folded marks and fine cracks to secure durability and a long lifespan of the display device. In addition, it is possible to provide a film suitable to be used as the window cover film of the flexible display device due to excellent transparency.

<Polyimide-Based Film>

In an aspect of the present invention, a polyimide-based film may be formed of a material having excellent optical and mechanical properties and having an elastic force and a restoring force.

In an aspect of the present invention, the polyimide-based film has a tear strength of 300 N/mm or more according to ASTM D1004 and a yellow index of 3 or less according to ASTM E313. The tear strength may preferably be 300 to 700 N/mm, and more preferably 350 to 500 N/mm, and the yellow index may be 2 to 3, and more preferably 2 to 2.5 By performing in-fold and out-fold at the same point in the above ranges, a film in which deformation and cracks of a folded portion may be minimized and optical properties are excellent even when repetitive fatigue occurs may be provided.

In addition, a tear strength T_{MD} in the machine direction(MD) and a tear strength T_{TD} in the transverse direction(TD) may satisfy the following Equation 1:

0.95≤T_{MD}/T_{TD}≤1.05. [Equation 1]

More specifically, in the above Equation 1, T_{MD}/T_{TD} may be 0.95 to 1.04, and more preferably 0.95 to 1.02. In the above range, a film having uniform physical properties may be provided over an entire area of the film, and a difference in physical properties between a central portion and a side portion of the film is small, such that an amount of film lost at the time of cutting the film may be minimized, thereby providing an economical effect.

In addition, a light transmittance of the polyimide-based film measured at 388 nm according to ASTM D1746 may be 5% or more, and more preferably 8% or more, a total light transmittance of the polyimide-based film measured at 400 to 700 nm according to ASTM D1746 may be 87% or more, more preferably 88% or more, and even more preferably 89% or more, and a haze of the polyimide-based film according to ASTM D1003 may be 2.0% or less, more preferably 1.5% or less, and even more preferably 1.0% or less. When the polyimide-based film is applied to the window cover film in ranges that satisfy not only the tear strength, but also the yellow index and the light transmittance, further improved durability and visual field properties may be exhibited, which is preferable.

In addition, the polyimide-based film may satisfy all of physical properties that a modulus of the polyimide-based film according to ASTM D882 is 3 GPa or more, preferably 4 GPa or more, and more preferably 5 GPa or more, and an elongation at break of the polyimide-based film is 10% or more, preferably 12% or more, and more preferably 20% or more, thereby providing mechanical properties and durability suitable for applying the polyimide-based film to the window cover film.

In addition, the polyimide-based film may satisfy physical properties that an in-plane retardation of the polyimide-based film measured with an Axoscan available from Axometrics, Inc., is 400 nm or less, preferably 350 nm or less, and more preferably 300 nm or less, thereby providing optical properties suitable for applying the polyimide-based film to the window cover film. More specifically, an in-plane retardation of the polyamide-based film may be, but is not limited to, 100 to 400 nm, more specifically 150 to 300 nm, and more specifically 190 to 290 nm.

In an aspect of the present invention, the polyimide-based film may have, but is not limited to, a thickness of 10 to 500 μm, 20 to 250 μm, or 30 to 90 μm.

In an aspect of the present invention, the polyimide-based film is formed of a polyimide-based resin, in particular, a polyimide-based resin having a polyamide-imide structure.

More specifically, the polyimide-based film may be formed of a polyimide-based resin having a polyamide-imide structure, including a unit derived from an aromatic diamine, a unit derived from an aromatic dianhydride, a unit derived from a cycloaliphatic dianhydride, and a unit derived from an aromatic diacid dichloride. Here, the unit derived from an aromatic diacid dichloride may be contained in an amount of 60 mol % or more, more specifically 60 to 90 mol %, more preferably 70 to 90 mol %, and even more preferably 70 to 85 mol %, based on the total moles of the unit derived from an aromatic dianhydride, the unit derived from a cycloaliphatic dianhydride, and the unit derived from an aromatic diacid dichloride, such that a film having a high tear strength may be provided. In addition, a film is manufactured using the polyimide-based resin described above by a specific manufacturing method, such that a film having a higher tear strength, a higher transmittance, and a lower yellow index may be provided.

In addition, the polyamide-imide-based resin includes a fluorine atom and an aliphatic cyclic structure, and accordingly, a film having a high tear strength may be provided. In addition, a film is manufactured using the polyamide-imide-based resin described above by a specific manufacturing method, such that a tear strength of the film may become higher, a mechanical strength of the film may be improved, and dynamic bending properties of the film may be further improved. Therefore, the film may be appropriately used as a window cover film of a flexible display subjected to a repeated folding and unfolding operation.

In addition, examples of the polyamide-imide-based resin including the fluorine atom and the aliphatic cyclic structure in the present invention may include a polyamide-imide-based resin obtained by mixing, polymerizing, and imidizing a fluorine-based aromatic diamine, an aromatic dianhydride, a cycloaliphatic dianhydride, and an aromatic diacid dichloride with each other. Such a resin has a random copolymer structure, and may be prepared by polymerizing the sum of the aromatic dianhydride, the cycloaliphatic dianhydride, and the aromatic diacid dichloride monomer with respect to the fluorine-based aromatic diamine monomer in a molar ratio of 1:0.8 to 1.1. The sum of the aromatic dianhydride, the cycloaliphatic dianhydride, and the aromatic diacid dichloride monomer is preferably polymerized with respect to the fluorine-based aromatic diamine monomer in a molar ratio of 1:1.

More specifically, for example, the molar ratio of the fluorine-based aromatic diamine:the aromatic dianhydride:the cyclic aliphatic dianhydride:the aromatic diacid dichloride may be 100:5 to 20:5 to 20:60 to 90. More specifically, the molar ratio may be 100:10 to 20:5 to 15:70 to 85. In addition, the molar ratio of the aromatic dianhydride and the cycloaliphatic dianhydride may be 1:0.5 to 3, more specifically 1:1.1 to 2.

In an aspect of the present invention, as the fluorine-based aromatic diamine component, a combination of 2.2′-bis(trifluoromethyl)-benzidine and other known aromatic diamine components may be used, but 2.2′-bis(trifluoromethyl)-benzidine may be used alone. An excellent optical property and a yellow index may be improved based on the mechanical properties of the polyamide-imide-based film required in the present invention by using such a fluorine-based aromatic diamine. In addition, a mechanical strength of a hard coating film may be improved and dynamic bending properties of the hard coating film may be further improved by improving a fine flexural modulus of the polyamide-imide-based film.

The aromatic dianhydride may be selected from at least one or two or more selected from the group consisting of 4,4′-hexafluoroisopropylidene diphthalic anhydride (6FDA) and biphenyltetracarboxylic dianhydride (BPDA), 4,4′-oxydiphthalic dianhydride (ODPA), sulfonyl diphthalic anhydride (SO2DPA), (isopropylidenediphenoxy) bis (phthalic anhydride) (6HDBA), 4-(2,5-dioxotetrahydrofuran-3-yl)-1,2,3,4-tetrahydronaphthalene-1,2-dicarboxylic dianhydride (TDA), 1,2,4,5-benzene tetracarboxylic dianhydride (PMDA), benzophenone tetracarboxylic dianhydride (BTDA), bis (3,4-dicarboxyphenyl) dimethyl silane dianhydride (SiDA), and bis (dicarboxyphenoxy) diphenyl sulfide dianhydride (BDSDA), but the present invention is not limited thereto.

The cycloaliphatic dianhydride may be, for example, any one or a mixture of two or more selected from the group consisting of 1,2,3,4-cyclobutanetetracarboxylic dianhydride (CBDA), 5-(2,5-dioxotetrahydrofuryl)-3-methylcyclohexene-1,2-dicarboxylic dianhydride (DOCDA), bicyclo[2.2.2]oct-7-ene-2,3,5,6-tetracarboxylic dianhydride (BTA), bicyclooctene-2,3,5,6-tetracarboxylic dianhydride (BODA), 1,2,3,4-cyclopentanetetracarboxylic dianhydride (CPDA), 1,2,4,5-cyclohexanetetracarboxylic dianhydride (CHDA), 1,2,4-tricarboxy-3-methylcarboxycyclopentane dianhydride (TMDA), 1,2,3,4-tetracarboxycyclopentane dianhydride (TCDA), and derivatives thereof.

In an aspect of the present invention, when an amide structure in a polymer chain is formed by the aromatic diacid dichloride, not only optical properties may be improved, but a mechanical strength may also be significantly improved, and a tear strength and dynamic bending properties may be further improved.

The aromatic diacid dichloride may be, but is not limited to, a mixture of two or more selected from the group consisting of isophthaloyl dichloride (IPC), terephthaloyl dichloride (TPC), 1.1′-biphenyl-4,4′-dicarbonyl dichloride (BPC), 1,4-naphthalene dicarboxylic dichloride (NPC), 2,6-naphthalene dicarboxylic dichloride (NTC), 1,5-naphthalene dicarboxylic dichloride (NEC), and derivatives thereof.

Hereinafter, a method of manufacturing the polyimide-based film will be described.

In an aspect of the present invention, the polyimide-based film may be manufactured by applying a “polyimide-based resin solution” containing the polyimide-based resin and a solvent onto a base, and then drying or drying and stretching the polyimide-based resin solution onto the base. That is, the polyimide-based film may be manufactured by a solution casting method.

As an example, a method of manufacturing the polyimide-based film may include: preparing a polyamic acid solution by reacting a fluorine-based aromatic diamine, an aromatic dianhydride, a cycloaliphatic dianhydride, and an aromatic diacid dichloride to each other, preparing a polyamide-imide resin by imidizing the polyamic acid solution, and forming a film by applying a polyamide-imide solution in which the polyamide-imide resin is dissolved in an organic solvent.

In this case, it is preferable to use an aromatic carbonyl halide monomer such as terephthaloyl chloride or isophthaloyl chloride rather than terephthalic acid ester or terephthalic acid itself in order to introduce the amide structure, and it seems as though a chlorine element affects physical properties of the film although it is not clear.

Here, an organic solvent used for polymerization may be, for example, any one or two or more polar solvents selected from the group consisting of dimethylacetamide (DMAc), N-methyl-2-pyrrolidone (NMP), dimethylformamide (DMF), dimethylsulfoxide (DMSO), ethyl cellosolve, methyl cellosolve, acetone, ethylacetate, and m-cresol.

Next, the preparing of the polyamide-imide resin by imidizing the polyamic acid solution may be performed through chemical imidization, and it is more preferable to chemically imidize the polyamic acid solution using pyridine and acetic anhydride. Subsequently, the polyamic acid solution may be imidized using an imidization catalyst and a dehydrating agent at a low temperature of 150° C. or less, preferably 100° C. or less, and more preferably 50 to 150° C.

This method makes it possible to impart uniform mechanical properties and tear strength to the entire film as compared to an imidization reaction by heat at a high temperature.

The imidization catalyst may be any one or two or more selected from the group consisting of pyridine, isoquinoline, and β-quinoline. In addition, the dehydrating agent may be, but is not necessarily limited to, any one or two or more selected from the group consisting of acetic anhydride, phthalic anhydride, and maleic anhydride.

In addition, the polyamide-imide resin may be prepared by mixing additives such as flame retardants, adhesion enhancers, inorganic particles, antioxidants, UV inhibitors, and plasticizers with the polyamic acid solution.

Further, after the imidization is performed, the resin may be purified using a solvent to obtain a solid, and the solid may be dissolved in the solvent to obtain a polyamide-imide solution. The solvent may include, but is not limited to, for example, N,N-dimethylacetamide (DMAc), etc.

The forming of the film by applying the polyamide-imide solution is performed by applying the polyamide-imide solution to a base and then drying the polyamide-imide solution in a drying step partitioned into drying regions. In addition, stretching may be performed after or before drying the polyamide-imide solution, if necessary, and a heat treatment step may be further provided after the drying or stretching step. The base may be, but is not limited to, for example, a glass, a stainless steel, or a film, etc. The application may be performed by, but is not limited to, a die coater, an air knife, a reverse roll, a spray, a blade, a casting, a gravure, a spin coating, etc.

In an aspect of the present invention, more specifically, the forming of the film by applying the polyamide-imide solution may include a drying step partitioned into a plurality of drying regions and a stretching step partitioned into a plurality of stretching regions after applying the polyamide-imide solution to the base. As described above, it is more preferable to manufacture the film under a specific drying condition and stretching condition because a hard coating film that has significantly improved bending properties and does not have a wave pattern, a rainbow and a mura phenomena according to a viewing angle may be obtained.

The drying step partitioned into the plurality of drying regions has drying regions of which a drying region positioned at a rear end is set to have a temperature higher than a temperature of a drying region positioned immediately before this drying region, and drying regions positioned at a rear end except for a first drying region are set to have high temperatures that are the same as or exceed temperatures of drying regions positioned immediately before these drying regions, respectively.

In the stretching step partitioned into the plurality of stretching regions, the film may be stretched at a stretching width within 110% of a film width of a first stretching region up to a final stretching region, the respective stretching regions are set to have temperatures higher than temperatures of stretching regions immediately before the respective stretching regions, respectively, and in the final stretching region and two stretching regions from the final stretching region, the film may be shrinkage-stretched to have a stretching width lower than a stretching width in a stretching region positioned immediately before these stretching regions.

More specifically, a drying condition is a condition under which the film is dried in a plurality of drying zones, preferably, four drying regions, in which a specific temperature program is programmed. The drying step partitioned into the plurality of drying regions may have drying regions of which a drying region positioned at a rear end is set to have a temperature higher than a temperature of a drying region positioned immediately before this drying region, and drying regions positioned at a rear end except for a first drying region may be set to have high temperatures that are the same as or exceed temperatures of drying regions positioned immediately before these drying regions, respectively.

In addition, characteristics of the present invention may be achieved by applying a specific temperature condition and stretching condition to the stretching region and the plurality of stretching regions. That is, in the stretching step partitioned into the plurality of stretching regions, the film may be stretched at a stretching width within 110% of a film width of a first stretching region up to a final stretching region, the respective stretching regions are set to have temperatures higher than temperatures of stretching regions immediately before the respective stretching regions, respectively, and in the final stretching region and two stretching regions from the final stretching region, the film may be shrinkage-stretched to have a stretching width lower than a stretching width in a stretching region positioned immediately before these stretching regions.

More specifically, a base layer according to an aspect of the present invention, more specifically, a polyamide-imide-based film, may be obtained by adopting a plurality of drying regions having different temperatures when the film is manufactured by applying a casting solution in which a polyamide-imide-based resin is dissolved onto a base or a conveyer belt by a solution coating method, drying the casting solution, performing stretching, and then performing heat treatment, drying the film at a higher temperature in a drying region positioned behind the drying region than in a drying region positioned in front of the drying region, and adopting a drying step of adjusting a final solvent content of the film dried in the drying region to 15 to 30 wt %.

In addition, when a solvent content of the finally dried film is satisfied, it is preferable that drying times in each region (each step) are the same or approximately the same as each other (here, a phrase “approximately the same” refers to a difference within 10% in a drying time from front end) because mechanical properties may be improved and a coating property of a hard coating composition may be improved. However, the drying step according to the present invention is not particularly limited since an object of the present invention may be achieved as long as a staying time in a rear drying region becomes longer than a staying time in a front drying region as a film to be dried in the front drying region moves to the rear drying region in the plurality of drying regions. It is not preferable that the staying time becomes short because sufficient mechanical strength for the purpose of the present invention may not be obtained.

The meaning that the drying temperature becomes high toward the rear drying region in the abovementioned drying step is that a second drying region of an initial drying region is set to have a temperature higher than that of a first drying region and a temperature of a drying region behind the second drying region is not lower than that of the second drying region. That is, when drying regions after the second drying region are rear drying regions, the rear drying regions may be set to have temperatures that are the same or approximately the same as each other.

Specifically, for example, it is more preferable for the purpose of uniform reproduction mechanical properties and of a hybrid folding resistance force to adopt a drying step having four-step or more drying regions. For example, when the drying region is divided into four steps, drying may be performed at 70 to 100° C. for one to five minutes in a first drying region, be performed at 90 to 130° C. for one to five minutes in a second drying region, be performed at 120 to 160° C. for one to five minutes in a third drying region, and be performed at 120 to 160° C. for one to five minutes in a fourth drying region, and the film may be dried at a temperature programmed to be higher in a rear drying region than in a front drying region in each step. Alternatively, the drying is performed at a higher temperature in the second to fourth drying regions except for the first drying region in the first drying region, and temperatures of the second to fourth drying regions are the same each other or gradually rise.

More specifically, the first drying region may be set to have a temperature of 85° C., the second drying region may be set to have a temperature of 115° C., the third drying region may be set to have a temperature of 130° C., and the fourth drying region may be set to have a temperature of 135° C. Alternatively, the first drying region may be set to have a temperature of 85° C., the second drying region may be set to have a temperature of 115° C., the third drying region may be set to have a temperature of 130° C., and the fourth drying region may be set to have a temperature of 130° C.

In addition, an aspect of the present invention may provide a polyamide-imide-based film according to the present invention having an excellent hybrid folding resistance force as long as a solvent content of a finally stretched film is maintained to be wt % or less, more preferably, 2 wt % or less, and most preferably, 1 wt % or less by adopting a process of drying the polyamide-imide-based film in the drying step, peeling off the dried polyamide-imide-based film containing 15 to 30 wt % of solvent from the base or the conveyer belt, and then stretching the polyamide-imide-based film in a tenter.

That is, in an aspect of the present invention, a tenter stretching step is divided into a plurality of stretching regions, the film is stretched at a higher temperature and a larger stretching width in each stretching region than in a stretching region before each stretching region, and when a final stretching region of the stretching step or the stretching region are divided into four or more steps, in a case where the film is shrinkage-stretched at a smaller stretching width in the final stretching region or final two stretching regions positioned at a rear end than in a front stretching region and the stretching step ends, a new polyamide-imide-based film having significantly improved mechanical properties and hybrid folding resistance force may be provided.

In the present invention, a stretching width or a stretch ratio refers to a size of a relative width of the first stretching region to a width of the film. For example, a stretching width or stretch ratio of 110% refers to a size of a relative width of the first stretching region to the width of the film. Specifically, stretching a film having a width of 1 m in a first stretching step at a stretching width of 110% in a second stretching step means that the film is stretched to have a width of 1.1 m.

In addition, shrinkage-stretching means that the film is stretched at a stretching width smaller than a stretching width at a front end. For example, when the film is stretched at a stretching width of 110% in the second stretching region and is then stretched at a stretching width of 105% in the third stretching region, it means that shrinkage-stretching is performed in the third stretching region.

More preferably, when the stretching width in the stretching region is 110% or less, and more preferably 105% or less, of the width of the film introduced into the stretching region, and a condition in the stretching region is satisfied, mechanical properties and a hybrid folding resistance force for the purpose of the present invention may be exhibited. In addition, in an aspect of the present invention, the condition of the drying region and the condition of the stretching region are satisfied, such that an effect of the present invention may be further increased.

In addition, in an aspect of the present invention, it is preferable in achieving an object of the present invention to set a temperature of the first stretching region into which the film is first injected in the drying step to a temperature increased from a temperature of a final drying region of the drying step by 0 to 50° C., in the stretching step divided into the plurality of regions. When the temperature of the first stretching region is out of the above temperature range, mechanical properties and a coating property of a hard coating layer may be deteriorated.

<Window Cover Film>

In addition, another aspect of the present invention provides a window cover film including the polyimide-based film described above; and a coating layer formed on the polyimide-based film.

When the coating layer is stacked on the polyimide-based film having a change rate in a surface hardness in a specific range, the window cover film in which a visibility is significantly improved may be provided.

In an aspect of the present invention, the window cover film may satisfy all of physical properties that a light transmittance measured at 388 nm according to ASTM D1746 is 3% or more, a total light transmittance measured at 400 to 700 nm according to ASTM D1746 is 87% or more, 88% or more, or 89% or more, a haze according to ASTM D1003 is 1.5% or less, 1.2% or less, or 1.0% or less, a yellow index according to ASTM E313 is 4.0 or less, 3.0 or less, or 2.0 or less, and a value according to ASTM E313 is 2.0 or less, 1.5 or less, or 1.2 or less.

According to an aspect of the present invention, the coating layer is a layer for imparting functionality of the window cover film, and may be variously applied depending on purposes.

As a specific example, the coating layer may include, but is not limited to, any one or more layers selected from the group consisting of a restoration layer, an impact diffusion layer, a self-cleaning layer, an anti-fingerprint layer, an anti-scratch layer, a low refractive index layer, and an impact absorbing layer.

Even though various coating layers are formed on the polyimide-based film as described above, it is possible to provide the window cover film in which a display quality is excellent, optical properties are excellent, and in particular, a rainbow phenomenon is significantly reduced.

In an aspect of the present invention, specifically, the coating layer may be formed on one surface or both surfaces of the polyimide-based film. For example, the coating layer may be disposed on an upper surface of the polyimide-based film or may be disposed on each of upper and lower surfaces of the polyimide-based film. The coating layer may protect the polyimide-based film having excellent optical and mechanical properties from external physical or chemical damage.

In an aspect of the present invention, the coating layer may be formed to have a content of solid of 0.01 to 200 g/m² with respect to the total area of the polyimide-based film. The coating layer may preferably be formed to have a content of solid of 20 to 200 g/m² with respect to the total area of the polyimide-based film. The above-described basis weight is provided, such that surprisingly, a rainbow phenomenon does not occur while maintaining functionality, and excellent visibility may thus be implemented.

In an aspect of the present invention, specifically, the coating layer may be formed by applying a composition for forming a coating layer including a coating solvent onto the polyimide-based film. The coating solution is not particularly limited, and may preferably be a polar solvent. The polar solvent may be, for example, any one or more solvents selected from the group consisting of ether-based solvents, ketone-based solvents, alcohol-based solvents, amide-based solvents, sulfoxide-based solvents, and aromatic hydrocarbon-based solvents. Specifically, the polar solvent may be any one or more solvents selected from the group consisting of dimethylacetamide (DMAc), N-methyl-2-pyrrolidone (NMP), dimethylformamide (DMF), dimethylsulfoxide (DMSO), acetone, ethylacetate, propylene glycol methyl ether, m-cresol, methanol, ethanol, isopropanol, butanol, 2-methoxyethanol, methyl cellosolve, ethyl cellosolve, methyl ethyl ketone, methyl butyl ketone, methyl isobutyl ketone, methyl phenyl ketone, diethyl ketone, dipropyl ketone, cyclohexanone, hexane, heptane, octane, benzene, toluene, and xylene.

In an aspect of the present invention, a method of forming the coating layer by applying the composition for forming a coating layer onto the polyimide-based film may be, but is not limited to, for example, any one or more methods selected from a s spin coating method, an immersion method, a spray method, a die coating method, a bar coating method, a roll coater method, a meniscus coating method, a flexo printing method, a screen printing method, a bead coating method, an air knife coating method, a reverse roll coating method, a blade coating method, a casting coating method, and a gravure coating method.

In an aspect of the present invention, the window cover film may further include a base layer. The base layer may be formed on the other surface of the polyimide-based film on which the coating layer is not formed.

In an aspect of the present invention, the polyimide-based film may be manufactured as a film and then stacked on the base layer or may be stacked after applying and coating a polyamic acid resin composition, which is a precursor of the polyimide-based film, but is not particularly limited as long as the above-described stack configuration may be formed.

In an aspect of the present invention, the base layer is not particularly limited as long as it is a base film of a commonly used window cover film, but may include, for example, any one or more selected from the group consisting of an ester-based polymer, a carbonate-based polymer, a styrene-based polymer, and an acrylic-based polymer. Specifically, the base layer may include, but is not limited to, any one or more selected from the group consisting of polyethylene terephthalate, polyethylene naphthalate, polybutylene terephthalate, polybutylene naphthalate, polycarbonate, polystyrene, and polymethyl methacrylate.

In an aspect of the present invention, the base layer may be a single layer or may be a multilayer in which two or more are stacked. Specifically, the base layer may be obtained by stacking an optical adhesive layer on an interface between two or more base films.

In an aspect of the present invention, the base layer may have a thickness of 50 to 300 μm. The base layer may have a thickness of preferably 100 to 300 μm, and more preferably 150 to 250 μm. The base layer may have the thickness as described above to satisfy mechanical properties and significantly reduce a distortion phenomenon of light when the polyimide-based film is stacked.

In an aspect of the present invention, as a specific example, the optical adhesive layer may include, but is not limited to, any one or more selected from the group consisting of an optical clear adhesive (OCA), an optical clear resin (OCR), and a pressure sensitive adhesive (PSA).

In an aspect of the present invention, the window cover film may further include a second optical adhesive layer formed on an interface between the base layer and the polyimide-based film.

Specifically, the second optical adhesive layer formed on the interface between the base layer and the polyimide-based film may be formed of a material that is same as or different from that of the optical adhesive layer in the base layer described above, and may be formed to have a thickness of, for example, 20 to 120 μm. The second optical adhesive layer may be formed to have a thickness of preferably 20 to 80 μm. When the second optical adhesive layer is formed to have a thickness in the above range, the window cover film may implement overall excellent optical properties and a light distortion suppressing effect.

In an aspect of the present invention, the window cover film has a high surface hardness and an excellent flexibility to be lighter and have a more excellent durability against deformation than tempered glass, and is thus excellent as a window substrate on the outermost surface of a flexible display panel.

Another aspect of the present invention provides a display device including a display panel and the window cover film described above formed on the display panel.

In an aspect of the present invention, an application field of the display device is not particularly limited as long as it is a field requiring excellent optical properties, and a display panel appropriate for such a field may be selected and provided. Preferably, the window cover film may be applied to a flexible display device. As a specific example, the window cover film may be applied to, but is not limited to, any one or more image display devices selected from various image display devices such as a liquid crystal display device, an electroluminescent display device, a plasma display device, and a field emission display device.

In the display device including the window cover film of the present invention described above, display quality is excellent, and a distortion phenomenon due to light is significantly reduced, such that, in particular, a rainbow phenomenon in which a rainbow color mura occurs may be significantly suppressed and a user's eye fatigue may be minimized due to excellent visibility.

<Flexible Display Panel>

According to an aspect of the present invention, a flexible display panel or a flexible display device including the window cover film according to the above aspect may be provided.

Here, the window cover film may be used as the outermost window substrate of the flexible display device. The flexible display device may be various image display devices such as a general liquid crystal display device, an electroluminescent display device, a plasma display device, and a field emission display device.

Hereinafter, the present invention will be described in more detail on the basis of Examples and Comparative Examples. However, the following Examples and Comparative Examples are only examples for describing the present invention in more detail, and the present invention is not limited by the following Examples and Comparative Examples.

Hereinafter, physical properties were measured as follows.

1) Pencil Hardness

A pencil hardness was measured on the basis of a case where a line of 20 mm was drawn at a speed of 50 mm/sec using a load of 750 g, this process was repeated five or more times, and one or more scratches occurred, with respect to a film according to JIS K5400.

2) Modulus and Elongation at Break

A modulus and an elongation at break were measured using UTM 3365 (Instron Corp.) under conditions of pulling a polyamide-imide film having a length of 50 mm and a width of 10 mm at 50 mm/min at 25° C. according to ASTM D882.

The thickness of the film was measured and the measured thickness was input into an instrument. The modulus is represented by GPa and the elongation at break is represented by %.

3) Weight Average Molecular Weight

A weight average molecular weight and a polydispersity index of the manufactured film were measured using gel permeation chromatography (GPC) (Waters GPC system, Waters 1515 isocratic HPLC Pump, Waters 2414 Refractive Index detector) after dissolving a film sample in a DMAc eluent containing 0.05 M LiBr. At the time of the measurement, a GPC column was connected to Olexis, Polypore and mixed D columns, a DMAc solution was used as the solvent, polymethylmethacrylate (PMMA STD) was used as a standard, and an analysis was performed at a flow rate of 1 mL/min at 35° C.

4) Light Transmittance

A total light transmittance was measured over an entire wavelength region of 400 to 700 nm using a spectrophotometer (Nippon Denshoku, Industries Co., Ltd., COH-400) and a single-wavelength transmittance was measured at 388 nm using an UV/Vis (Shimadzu, UV3600), with respect to a film having a thickness of 50 μm according to ASTM D1746 standard. The light transmittance is represented by %.

5) Haze

A haze was measured using a spectrophotometer (Nippon Denshoku Industries Co., Ltd., COH-400), with respect to a film having a thickness of 50 μm according to ASTM D1003 standard. The haze is represented by %.

6) Yellow Index (YI) and b* Value

A yellow index and a b* value were measured using a colorimeter (Hunter Associates Laboratory, Inc., ColorQuest XE), with respect to a film having a thickness of 50 μm according to ASTM E313 standard.

7) Tear Strength

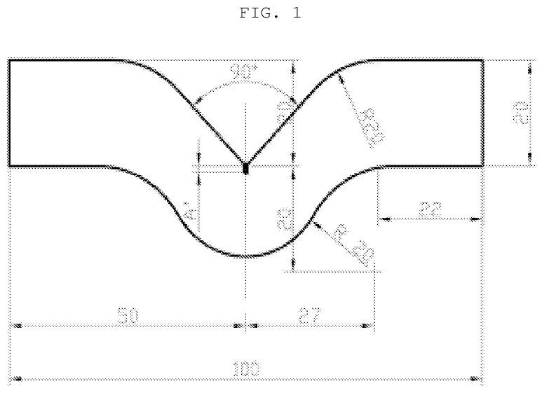

According to ASTM D1004, a specimen having a shape as illustrated in FIG. 1 was laser-cut and was mounted on a UTM (Instron, 3365), a speed was set to 51 mm/min and a grip distance was set to 25.4 mm, and a tear strength was then measured.

A total of three samples were prepared from a central portion and both side portions of the film in a transverse direction(TD), tear strengths were measured for each of the three samples, and an average value of the tear strengths was obtained.

8) Evaluation of Folding Properties

A film was laser-cut to a width of 100 mm and a length of 200 mm, the film was fixed to a folding tester (YUASA, Inc.) using an adhesive, a folding radius was set to 5 mm, an in-folding test was repeatedly performed 200,000 times at a speed of 60 cycles/min, and an out-folding test was performed 200,000 times at a speed of 60 cycles/min so that the same sample was folded at the same position, and it was confirmed with a microscope whether or not cracks (length of 2 cm or more and width of 0.01 mm or more) exist in the folded portion.

9) In-Plane Retardation

Samples having a width of 2 cm and a length of 2 cm were prepared at intervals of 10 cm with respect to an entire width of a film, angles between incident light and a film surface were measured at intervals of 10° at a wavelength of 550 nm using an Axoscan (Axometrics, Inc.), retardations up to 50° were measured, and an average value was then obtained.

### Example 1

2,2′-bis(trifluoromethyl)-benzidine (TFMB) was added to a mixed solution of dichloromethane and pyridine in a reactor and the mixture was stirred sufficiently, and 4,4′-hexafluoroisopropylidenediphthalic anhydride (6FDA), cyclobutanetetracarboxylic dianhydride (CBDA) were sequentially added and the mixture was then stirred at 25° C. for 2 hours. Thereafter, terephthaloyl dichloride (TPC) was added and the mixture was then stirred at 40° C. for 10 hours to be dissolved and reacted, thereby preparing a polyamic acid resin composition. Here, amounts of respective monomers were used in a molar ratio of TFMB:6FDA:CBDA:TPC of 100:15:13:72, and a content of solid was adjusted to be 20 wt %.

Then, each of pyridine and acetic anhydride was added to the solution 2.5 times the moles of the total dianhydride content, and the mixture was stirred at 60° C. for 12 hours.

After polymerization was completed, a solid obtained by cooling the polymerized solution to room temperature, precipitating the polymerized solution in an excessive amount of methanol, and then performing filtering was dried under vacuum at 50° C. for 6 hours or more to obtain a polyamide-imide powder. The polyamide-imide powder was diluted and dissolved in a DMAc at 20% to prepare a polyamide-imide solution.

The prepared polyamide-imide solution was coated on a PET base film, and a polyamide-imide film was continuously manufactured in a drying region separated into four regions and a tenter stretching region separated into five regions.

First, the composition for forming a base layer was continuously coated on the PET base film at room temperature using a slot die, and dried in a drying region designed to have four drying regions. The drying was performed at 85° C. for 2 minutes in a first drying region, was dried at 115° C. for 2 minutes in a second drying region, was performed at 130° C. for 2 minutes in a third drying region, and was performed at 140° C. for 2 minutes in a fourth drying region. A content of solvent in the film passing through the drying regions was 22 wt %.

Then, the dried film was separated from the PET base film, and the PET base film was stretched using a pin tenter. The stretching region was partitioned into five regions, the base film was not stretched at 150° C. in a first stretching region, a second stretching region was set to have a temperature of 170° C. and the base film was stretched in a machine direction(MD) (MD) at 102% (it means that the base film was stretched 1.02 times the width of the first stretching region) in the second stretching region, a third stretching region was set to have a temperature of 210° C. and a stretching width of 102% is maintained in the third stretching region as it is, a fourth stretching region was set to having a temperature of 240° C. and the base film was shrinkage-stretched so that a stretching width becomes 101%, and a fifth stretching region was set to have a temperature of 240° C. and the base film was shrinkage-stretched in two steps at a stretching width of 100.5% in the fifth stretching region. A content of solvent in the film passing through the stretching region was adjusted to be 1.8 wt %. In the above, the stretching widths were calculated based on a stretching width of the film injected into the first stretching region.

Physical properties of the manufactured film were measured and are shown in Table 1 below.

### Example 2

A film was manufactured as follows using the polyamide-imide solution prepared in Example 1.

The prepared polyamide-imide solution was coated on the PET base film, dried at 80° C. for 30 minutes and 100° C. for 1 hour, and then cooled at room temperature to manufacture a film. Then, stepwise heat treatment was performed at 100 to 200° C. and 250 to 300° C. for 2 hours at a heating speed of 20° C./min.

Physical properties of the manufactured film were measured and are shown in Table 1 below.

### Example 3

A film was manufactured in the same manner as in Example 1 except that a molar ratio was adjusted as shown in Table 1 below, and physical properties of the manufactured film were shown in Table 1 below.

### Example 4

A film was manufactured in the same manner as in Example 1 except that a molar ratio was adjusted as shown in Table 1 below, and physical properties of the manufactured film were shown in Table 1 below.

### Comparative Examples 1 and 2

Films were manufactured in the same manner as in Example 1 except that molar ratios were adjusted as shown in Table 1 below, and physical properties of the manufactured films are shown in Table 1 below.

### Comparative Example 3

A film was manufactured in the same manner as in Example 2 except that a molar ratio was adjusted as shown in Table 1 below, and physical properties of the manufactured film are shown in Table 1 below.

TABLE 1

| | | | | | | Comp. | Comp. | Comp. |
|---|---|---|---|---|---|---|---|---|
| | | Example 1 | Example 2 | Example 3 | Example 4 | Example 1 | Example 2 | Example 3 |
| TFMB:6FDA:CBDA:TPC | | 100:15:13:72 | 100:15:13:72 | 100:10:5:85 | 100:20:10:70 | 100:50:20:30 | 100:30:20:50 | 100:70:0:30 |
| (molar ratio) | | | | | | | | |
| Multi-step drying and | | ◯ | X | ◯ | ◯ | ◯ | ◯ | X |
| multi-step stretching | | | | | | | | |
| Thickness (μm) | | 100 | 100 | 100 | 100 | 100 | 100 | 100 |
| Total light | | 89.8 | 88.2 | 89.5 | 89.4 | 88.9 | 88.7 | 88.3 |
| transmittance (%) | | | | | | | | |
| Haze (%) | | 0.4 | 0.8 | 0.5 | 0.7 | 1.3 | 1.2 | 1.1 |
| Yellow index (YI) | | 2.1 | 2.2 | 2.3 | 2.4 | 3.9 | 4.1 | 4.3 |
| b* | | 0.9 | 1.2 | 1.1 | 1.2 | 1.8 | 1.7 | 1.7 |
| In-plane retardation (nm) | | 190 | 290 | 200 | 205 | 410 | 450 | 415 |
| Modulus (GPa) | | 5.9 | 5.6 | 5.8 | 5.7 | 4.9 | 4.8 | 4.0 |
| Elongation at break (%) | | 22.2 | 18.5 | 21 | 19.8 | 7 | 10.6 | 5 |
| Weight average molecular | | 310,000 | 320,000 | 315,000 | 330,000 | 330,000 | 330,000 | 330,000 |
| weight (g/mol) | | | | | | | | |
| Pencil hardness | | HB | 1B | HB | HB | HB | 2B | HB |
| Tear | Machine | 461 | 350 | 450 | 420 | 140 | 160 | 120 |
| strength | direction(MD) | | | | | | | |
| (N/mm) | Transverse | 458 | 360 | 455 | 440 | 127 | 139 | 108 |
| | direction(TD) | | | | | | | |
| | T_{MD}/T_{TD} | 1.01 | 0.97 | 0.99 | 0.95 | 1.10 | 1.15 | 1.11 |

| | | | | | | | |
|---|---|---|---|---|---|---|---|
| Folding properties | No | No | No | No | Crack | Crack | Crack |
| | crack | crack | crack | crack | occurred | occurred | occurred |

It was confirmed from the above Table 1 that in Examples 1 to 4, both physical properties of a tear strength is 300 N/mm or more and a haze of 2 or less are satisfied and cracks do not occur even when in-folding and out-folding were repeated 200,000 times at the same position at the time of measuring the folding properties.

However, it was confirmed that when a content of TPC is less than 60 mol % as in Comparative Examples 1 to 3, a yellow index is 3 or more, which is high and a tear strength is low, such that cracks occur at the time of evaluating the folding properties.

In addition, it was confirmed that as shown in Examples and Comparative Examples, a film having a lower yellow index and a higher tear strength is manufactured by performing multi-step drying and multi-step stretching when the polyamide-imide film is manufactured. In addition, it was confirmed that at the time of evaluating the folding properties in a range where the tear strength is high and a difference in the tear strength in the machine direction(MD) and the transverse direction(TD) was not large, a folded mark does not occur and deformation of a folded portion may be minimized.

The polyimide-based film according to the present invention is flexible, is transparent and has a low yellow index to have excellent optical properties, and has an excellent tear strength, and a window cover film that may be applied to a flexible display device that may be in-folded and out-folded at a specific position may be thus provided.

In addition, a polyimide-based film and a window cover film in which a tear strength is high, a difference in a tear strength in a machine direction(MD) and in a transverse direction(TD) is small, and uniform mechanical properties (modulus, elongation, etc.) and optical properties (transmittance, yellow index, retardation, etc.) over a central portion and a side portion of the film are exhibited to minimize film loss may be provided.

Since the window cover film according to the present invention has a high surface hardness, is flexible, and has excellent bending properties, even if a predetermined deformation occurs repeatedly, a hard coating layer and the window cover film are not permanently deformed and/or damaged, and may be restored to their original shapes.

Hereinabove, although the present invention has been described by specific matters, the limited embodiments and drawings, they have been provided only for assisting in a more general understanding of the present invention. Therefore, the present invention is not limited to the exemplary embodiments. Various modifications and changes may be made by those skilled in the art to which the present invention pertains from this description.

Therefore, the spirit of the present invention should not be limited to the above-mentioned embodiments, but the claims and all of the modifications equal or equivalent to the claims are intended to fall within the scope and spirit of the present invention.

What is claimed is:

1. A polyimide-based film having a tear strength according to ASTM D1004 of 300 N/mm or more and a yellow index according to ASTM E313 of 3 or less.

2. The polyimide-based film of claim 1, wherein the tear strength is 300 to 700 N/mm.

3. The polyimide-based film of claim 1, wherein 0.95≤T_{MD}/T_{TD}≤1.05 in which T_{MD} is a tear strength of the polyimide-based film in a machine direction(MD) and T_{TD} is a tear strength of the polyimide-based film in a transverse direction(MD).

4. The polyimide-based film of claim 1, wherein the yellow index is 2 to 3.

5. The polyimide-based film of claim 1, wherein a light transmittance of the polyimide-based film measured at 388 nm according to ASTM D1746 is 5% or more, a total light transmittance of the polyimide-based film measured at 400 to 700 nm according to ASTM D1746 is 87% or more, and a haze of the polyimide-based film is 2.0% or less.

6. The polyimide-based film of claim 5, wherein the light transmittance of the polyimide-based film measured at 388 nm according to ASTM D1746 is 8% or more, the total light transmittance of the polyimide-based film measured at 400 to 700 nm according to ASTM D1746 is 89% or more, and the haze of the polyimide-based film is 1.0% or less.

7. The polyimide-based film of claim 1, wherein a modulus of the polyimide-based film according to ASTM D882 is 3 GPa or more, and an elongation at break of the polyimide-based film according to ASTM D882 is 8% or more.

8. The polyimide-based film of claim 1, wherein an in-plane retardation of the polyimide-based film measured at 550 nm using an Axoscan available from Axometrics, Inc., is 400 nm or less.

9. The polyimide-based film of claim 1, wherein the polyimide-based film includes a polyamide-imide structure.

10. The polyimide-based film of claim 9, wherein the polyimide-based film includes a unit derived from an aromatic diamine, a unit derived from an aromatic dianhydride, a unit derived from a cycloaliphatic dianhydride, and a unit derived from an aromatic diacid dichloride, and
the unit derived from an aromatic diacid dichloride is contained in an amount of 60 mol % or more based on the total moles of the unit derived from an aromatic dianhydride, the unit derived from a cycloaliphatic dianhydride, and the unit derived from an aromatic diacid dichloride.

11. The polyimide-based film of claim 10, wherein the unit derived from an aromatic diacid dichloride is contained in an amount of 70 to 90 mol %.

12. The polyimide-based film of claim 1, wherein the thickness of the polyimide-based film is 10 to 500 μm.

13. A window cover film, comprising:
the polyimide-based film of claim 1; and
a coating layer formed on at least one surface of the polyimide-based film.

14. The window cover film of claim 13, wherein the coating layer is any one or more selected from the group consisting of an anti-static layer, an anti-fingerprint layer, an anti-fouling layer, an anti-scratch layer, a low refractive layer, an anti-reflection layer, and an impact absorbing layer.

15. A flexible display panel comprising the polyimide-based film of claim 1.
